(19) United States
(12) Patent Application Publication
(10) Pub. No.: US 2007/0146935 A1
(43) Pub. Date: Jun. 28, 2007

(54) Magnetic disk apparatus

(75) Inventors: Hiroshi Minami, Kawaski (JP); Kouichi Toukairin, Kawasaki (JP); Hirofumi Suzuki, Kawasaki (JP); Hideki Yamaguchi, Kawasaki (JP); Hiroaki Kobayashi, Kawasaki (JP)

Correspondence Address: Patrick G. Burns;GREER, BURNS & CRAIN, LTD., Suite 2500, 300 South Wacker Drive, Chicago, IL, 60606, US

(73) Assignee: FUJITSU LIMITED

(21) Appl. No.: 11/399,574

(22) Filed: Apr. 6, 2006

(30) Foreign Application Priority Data
Dec. 28, 2005 (JP) 2005-378581

(51) Int. Cl. G11B 5/48

(52) U.S. Cl. 360/245.9

(57) ABSTRACT

A magnetic head support mechanism able to inexpensively, simply, and reliably suppress air disturbances accompanying high speed rotation of the magnetic disks, the magnetic head support mechanism having an actuator arm for moving a magnetic head, a long tail for laying read/write signal lines along the arm, and slits for holding the long tail at predetermined locations along the actuator arm, the long tail and slits generating friction, that is, forming a friction structure, to press fasten the members.

### BACKGROUND OF THE INVENTION

1. Field of the Invention

The present invention relates to a magnetic disk apparatus such as a hard disk drive (HDD) provided with a magnetic head support mechanism.

2. Description of the Related Art

Up until now, as typical structures of magnetic head support mechanisms in magnetic disk apparatuses, relay connection structures such as (i) preamplifiers for magnetic head signal amplification, (ii) flexible printed circuit boards (FPC) for relay, and (iii) terminals on suspensions, so-called short tail suspensions, have been employed.

However, it is necessary to increase the speed of data transfer along with the increase in the amount of data in the field of data processing. The interposition of such a FPC for relay has become an obstacle in this signal transfer.

Therefore, in recent years, there has been a shift from the structures of the above short tail suspensions to the structures of so-called long tail suspensions. A long tail suspension has been changed from the above relay connection structure with the above FPC for relay interposed in the middle to a direct connection structure without any FPC for relay interposed in the middle, that is, with the magnetic head and preamplifier directly connected.

This long tail type suspension, as will be explained later with reference to the figures, is for example comprised of a stainless steel sheet of the thickness of 20 μm. Insulated signal lines may be formed from the magnetic head to preamplifier in a thin film state on the surface of steel sheet. The long tail of the thus formed long tail suspension is accommodated and held in several slits provided at the side face of the actuator arm forming the magnetic head support mechanism. In this case, it is not enough to fit the long tail of the long tail suspension into the slits. It is also required that the long tail be held to be firmly fastened in the slits.

Note that as known art relating to the present invention, there are Japanese Patent Publication (A) No. 9-320213 and Japanese Patent Publication (A) No. 2005-78688. However, these known art do not suggest anything regarding a “friction structure not using any additional member” enabling press fastening of the long tail to the actuator arm or the slits like in the present invention explained in detail later.

By way of reference, the known art of Japanese Patent Publication (A) No. 9-320213 has as its object the realization of a head support mechanism enabling a FPC for relay to be securely fastened and the signal lines to be reliably and easily laid at the time of assembly and repair and is characterized by insertion of the FPC for relay in a groove provided at the actuator arm side face. Further, as embodiments of this, the formation of a long groove shape at the side face of the actuator arm, the formation of a plurality of short groove shapes, fastening by C-groove shapes or bending the arm grooves, and addition of C-rings or snap-in pins for preventing detachment of the FPC may be mentioned.

Further, in the known art of Japanese Patent Publication (A) No. 2005-78688, the method is disclosed of joining and fastening the slits and long tail suspension through an elastic member.

In forming the slits provided at the side face of the actuator arm, the spaces cannot be made narrow enough to enable the long tail suspension made of a sheet of 20 μm thickness to be sufficiently gripped. The reason is that it is extremely difficult to obtain a tool able to form slits having spaces of 20 μm or so inexpensively and with high durability. In the end, the slits have spaces of 0.4 mm or so at the smallest, larger than the thickness of the long tail suspension (20 μm).

Therefore, there was the problem that air disturbances caused by high speed rotation of the media (magnetic disks) and the vibration of the long tail suspension itself occurring at the time of driving the actuator arm made the magnetic head vibrate and caused the positioning precision to decline. Further, the effect of outside vibration and impact also could not be ignored.

Under these circumstances, according to Japanese Patent Publication (A) No. 9-320213, there was the problem that it was difficult to eliminate these inconveniences inexpensively and simply and with high tolerance against outside vibration and impact. Further, according to Japanese Patent Publication (A) No. 2005-78688, there was the problem that since a separate member was used to connect the actuator arm and the long tail suspension, extreme care was required at the time of assembly of the actuator arm and even at the time of reassembly or magnetic head replacement, so production and maintenance were difficult.

### SUMMARY OF THE INVENTION

An object of the present invention, in consideration of the above problems, is to provide a magnetic head support mechanism able to inexpensively, simply, and reliably suppress air disturbances accompanying high speed rotation of the magnetic disks and enable easy production and maintenance.

To achieve the above object, the present invention provides a magnetic disk apparatus with a magnetic head support mechanism (1) having an actuator arm (4) for moving a magnetic head (2), a long tail (5) for laying read/write signal lines along the arm (4), and slits (6) for holding the long tail 5 at predetermined locations along the actuator arm (4). Here, the long tail (5) and slits (6) generate friction, that is form a friction structure (7), to press fasten the members (5, 6).

### BRIEF DESCRIPTION OF THE DRAWINGS

These and other objects and features of the present invention will become clearer from the following description of the preferred embodiments given with reference to the attached drawings, wherein:

FIG. 1 is a view showing the basic configuration of the present invention;

FIG. 2A is a view showing a holding structure between a long tail suspension and slits according to the related art, while FIG. 2B is a view showing the holding structure according to the present invention;

FIG. 3 is a view showing a modification of the first embodiment;

FIG. 4 is a perspective view showing a second embodiment;

FIG. 5 is a view showing a modification of the second embodiment;

FIG. 6A and FIG. 6B are a perspective view and sectional view of a third embodiment;

FIG. 7 is a sectional view of a fourth embodiment;

FIG. 8 is a perspective view of a fifth embodiment;

FIG. 9 is a perspective view of a sixth embodiment;

FIG. 10 is a view of the appearance of a general magnetic disk apparatus; and

FIG. 11 is a view of an example of a general magnetic head support mechanism to which the present invention is applied.

### DESCRIPTION OF THE PREFERRED EMBODIMENTS

Preferred embodiments of the present invention will be described in detail below while referring to the attached figures.

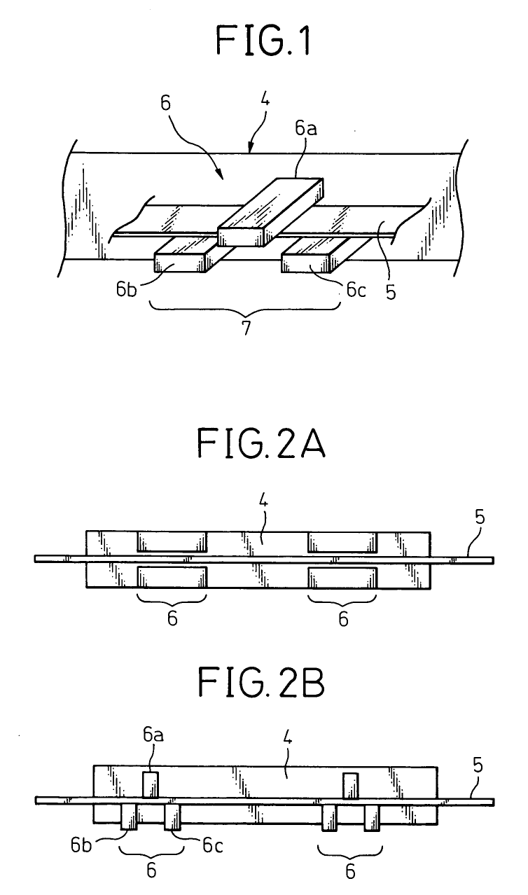

FIG. 1 is a view of the basic configuration of the present invention and shows the principal parts by an enlarged perspective view. In the figure, reference numeral 4 indicates an actuator arm, 5 a long tail of a long tail suspension, and 6 a slit. The slit is formed between holding members (6a, 6b, 6c) arranged alternately in the vertical and horizontal directions. Reference numeral 7 indicates a friction structure constituting the characterizing feature of the present invention.

More specifically, the magnetic head support mechanism shown in the figure (reference numeral 1 explained later) is a magnetic head support mechanism provided with an actuator arm 4 holding a magnetic actuator (later explained “3”) and making the magnetic head (later explained “2”) move to a predetermined position, a long tail 5 for laying signal lines connecting to the magnetic head (2) horizontally along the side face of the actuator arm 4, and vertical and horizontal alternate holding members (6a, 6b, and 6c) for holding the long tail 5 provided at that side face of this actuator arm 4 at predetermined locations of that side face.

Here, the characterizing feature of the present invention is the formation of a friction structure 7 for generating friction between the long tail 5 and the walls of the holding members (6a, 6b, and 6c) forming the slits 6 so as to hold the long tail 5 inside the slit 6.

According to the present invention, by giving a friction action to the original members (walls of holding members forming the slits 6 and long tail 5) so as to give rise to a resultant “press fastening” effect without introducing the above extraneous members or special structures, a magnetic disk apparatus is realized which provides a magnetic head support mechanism which simply and reliably suppresses the effects of above air disturbances and external vibration and further is easy to produce and maintain.

To clarify the effects brought about by the present invention, first, a general magnetic disk apparatus (HDD) will be simply explained.

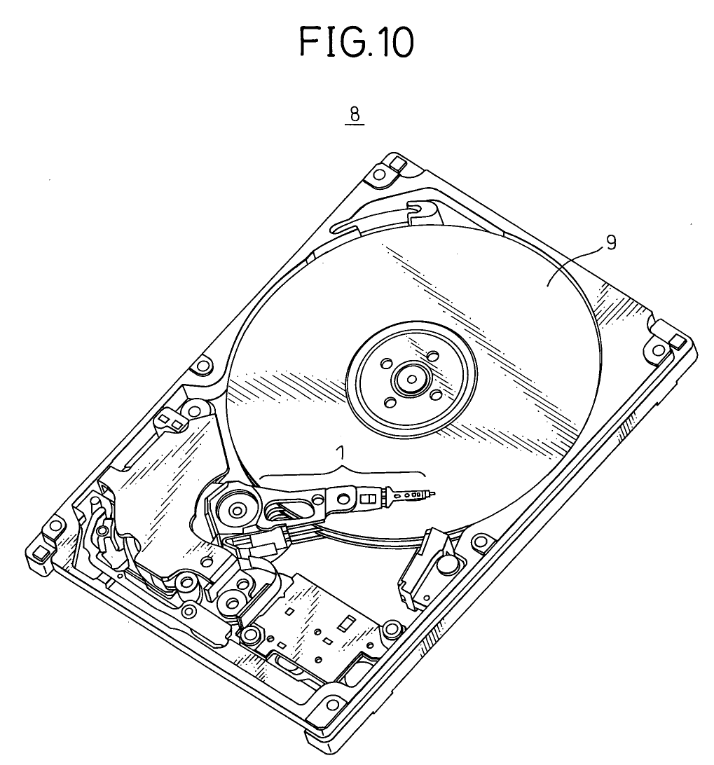

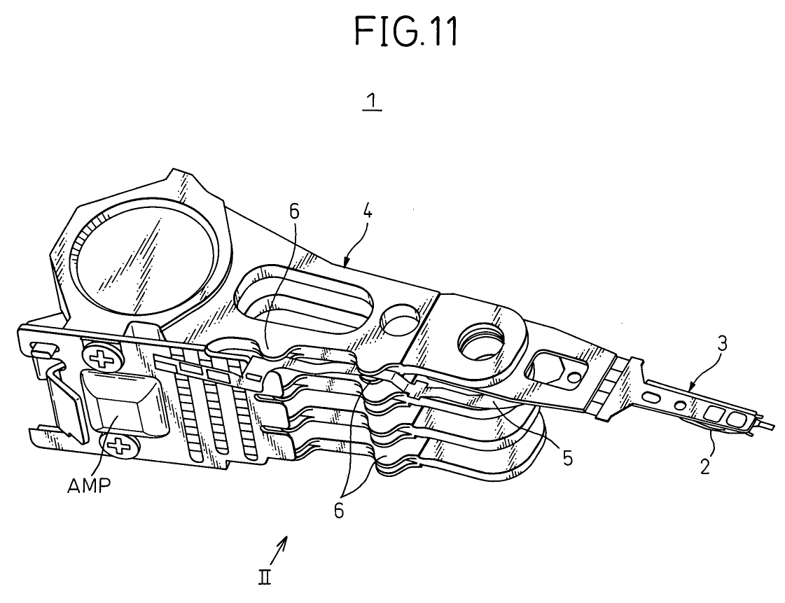

FIG. 10 is a view of the appearance of a general magnetic disk apparatus. In the figure, the magnetic disk apparatus 8 is comprised of a number of magnetic disks 9 and a magnetic head support mechanism 1 having a magnetic head (2) operating with the magnetic disks 9, the above-mentioned magnetic head suspension (3), and the above-mentioned actuator arm (4). The magnetic head support mechanism 1 shown in FIG. 10 employs a long tail suspension and usually has the configuration shown in FIG. 11. In the long tail suspension, a long tail suspension plate (stainless steel sheet) is provided with an interconnect circuit electrically connecting to the magnetic head 2 at one side of the plate. The interconnect circuit runs from the front end where the magnetic head is attached to the other end at the carriage body side holding the actuator arm along the long direction of the long tail suspension plate. This interconnect circuit in general is provided with two signal lines for the magnetic head 2 to write to the magnetic disk 9 and two signal lines for it to read from the disk, that is, a total of four lines. Note that the long tail type suspension is comprised of a suspension plate made of a thin sheet of stainless steel successively provided with an insulating layer, circuit layer, and protective layer and is given a predetermined shape by etching the stainless steel.

FIG. 11 is a view of an example of a general magnetic head support mechanism 1 to which the present invention is applied. As already explained, this magnetic head support mechanism 1 supports a magnetic head suspension 3 for holding the magnetic head 2 and an actuator arm 4 and is provided with the slits 6 at its side face. The long tail 5 of the long tail suspension handling the signal transfer between the front end where the magnetic head 2 is mounted and the existing preamplifier AMP is accommodated in and held at the slits 6 horizontally with respect to the actuator arm 4.

Therefore, here, the holding structure between the long tail 5 of the long tail suspension and the slits 6 in the related art will be viewed while referring to the drawings. FIG. 2A shows the holding structure of the related art between the long tail 5 and the slits 6 of the related art, while FIG. 2B shows the holding structure according to the present invention. Note that FIGS. 2A and 2B correspond to the front views along the arrow II of FIG. 11. Therefore, FIG. 1 shows sets of the slit pieces 6a, 6b, and 6cin FIG. 2B. The two sets shown in FIG. 2B are the same in structure.

The point to note in the above FIG. 2A is that, as explained above, if for example fitting the 20 μm thick long tail 5 into conventional slits 6 having spaces of only about 0.4 mm at the smallest, clearances will end up being formed. The above known art has been proposed for preventing air disturbances etc. arising due to the clearances.

Therefore, the friction structure of the first embodiment shown in FIG. 2B is employed to eliminate the above clearances and give rise to a “press fastening effect” between the long tail 5 and the slits 6. That is, if setting the upper and lower clearances with the slit pieces 6a and the slit pieces 6b and 6c to be substantially the same as the thickness of the long tail 5 (+production variance) and arranging them as illustrated, the above clearances are completely eliminated and a press fastening effect arises between the tail 5 and slits 6. In short, the present invention is characterized by forming the slits 6 by a plurality of slit pieces 6a, 6b, and 6calternately arranged so as to sandwich the long tail 5 from the vertical and horizontal sides and by forming a friction structure (7) between these slit pieces and the long tail 5. Note that in this embodiment, the holding members for holding the long tail, that is, the slit pieces 6a, 6b, and 6c, are formed projecting out from parts of the actuator arm.

In this case, according to a first aspect of the first embodiment, as shown in FIG. 2A, the plurality of slit pieces 6a, 6b, and 6csandwich the long tail 5 from the vertical and horizontal sides while maintaining it substantially horizontal to the arm plane of the actuator arm.

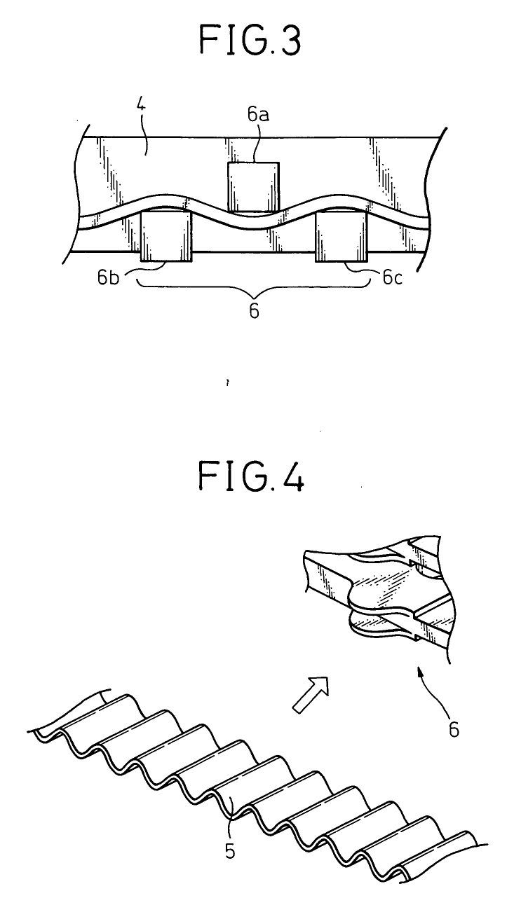

FIG. 3 is a view of a modification of the first embodiment, that is, is a view of a second aspect of the first embodiment. For simplification, however, only one set of the slit pieces 6a, 6b, and 6cis shown. This second aspect is characterized by arranging the plurality of slit pieces 6a, 6b, and 6cso that the distance between the slit pieces 6a, 6b, and 6cbecomes smaller than the thickness of the long tail so that when attaching the long tail 5, it is pushed from vertical and horizontal sides to deform into a bow shape. By doing this, the friction action between the long tail 5 and the walls of the slits 6, that is the press fastening effect, is increased more. Note that the configuration of supporting the slit 6 by three points (6a, 6b, and 6c) is shown, but two-point support is also possible or four-point support is also possible.

Next, the second embodiment will be explained. FIG. 4 is a perspective view of the second embodiment. As shown in the figure, in the second embodiment, the long tail 5 of the long tail suspension plate is bent into a wave shape comprised of alternate peaks and valleys. The above-mentioned friction structure is formed between the thus flexible wave-shaped long tail 5 and the upper and lower walls of the slit 6. Note that in this embodiment, the slit 6 is formed by a pair of holding members with facing upper and lower walls, and the upper and lower walls of the slit sandwich between them the wave shaped part of the long tail without clearance. Accordingly, the height difference between the peaks and valleys of the wave shape is substantially the same as or smaller than the space of the slit. For this reason, in this embodiment, it is sufficient to just modify the long tail suspension, so a friction structure having a good frictional force can be easily realized without any design change in the long tail holding mechanism of the actuator arm.

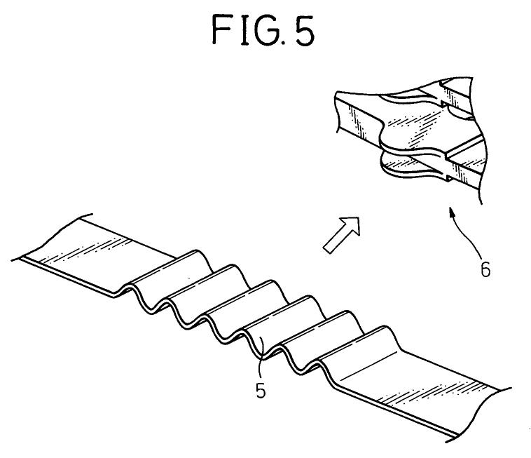

FIG. 5 is a view of a modification of the second embodiment, that is, a view of a second aspect of the second embodiment. As shown in the figure, in this second aspect, the long tail 5 is characterized by being made the above-mentioned wave shape in the length direction only at the part sandwiched in the slits 6. By making the long tail 6 partially a wave shape, the signal lines on the long tail type suspension can be shortened somewhat from the case of FIG. 4. Therefore, in this embodiment, the signal lines can be made shorter than the case of FIG. 4, so the effect of noise on the signal lines can be reduced. Further, the effect given by the wave shape forming process on the signal lines can be reduced to reduce the reject rate and streamline the wave shape forming process.

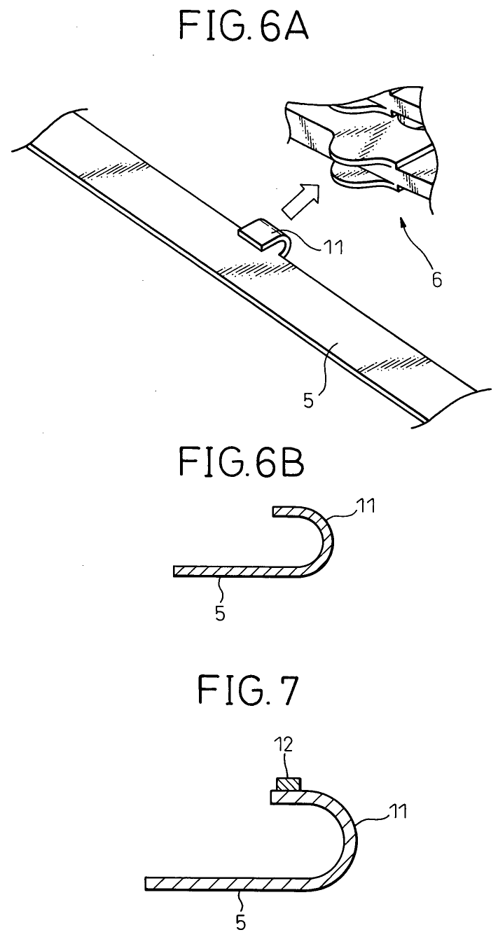

Next, a third embodiment will be explained. FIGS. 6A and 6B are a perspective view and a sectional view of the third embodiment. As shown in the figures, in the third embodiment, the stainless steel sheet of the long tail 5 is provided with a part extending from the side face toward the actuator arm side. This extended part is bent to form a substantially U-sectional shaped tab 11 facing the upper wall or lower wall of the slit 6. This forms the friction structure between the tab 11 and upper wall or lower wall of the slit 6. The tab 11 is formed by bending a stainless steel sheet, so has some springiness and is sandwiched between the upper and lower walls of the slit 6 without clearance thereby enabling the long tail 5 to be held. Note that the distance between the bent sides of the tab is made substantially the same as or smaller than the space of the slit 6 considering the springiness of the tab. Therefore, in this embodiment, there is no need to make the long tail longer like in the second embodiment or to bend the part including the interconnect circuit of the long tail suspension, so a friction structure can be realized simply without requiring any complicated steps.

FIG. 7 is a sectional view of a fourth embodiment and a modification of FIG. 6B. That is, in the fourth embodiment, the long tail, like in FIG. 6B, is comprised of the stainless steel sheet of the long tail 5 of the long tail type suspension provided with a part extending from the side face toward the actuator arm 4 side (in other words, extending in the direction perpendicular to the long direction of the long tail). This extended part is bent to form a U-sectional shape tab 11 facing the upper wall or lower wall of the slit 6. The tab 11 is further provided with an embossed part 12. The friction structure is formed between this embossed part 12 and the upper wall or lower wall of the slit 6. Note that the embossed part 12 can be formed integrally simultaneously with the extended part when press forming the long tail suspension. Further, the distance between the bent sides of the tab 11 can be determined considering the springiness of the tab 1, the height of the embossed part 12, the thickness of the long tail suspension, and their variances. According to the fourth embodiment, the press fastening effect due to the embossed part 12 becomes much greater than with the third embodiment.

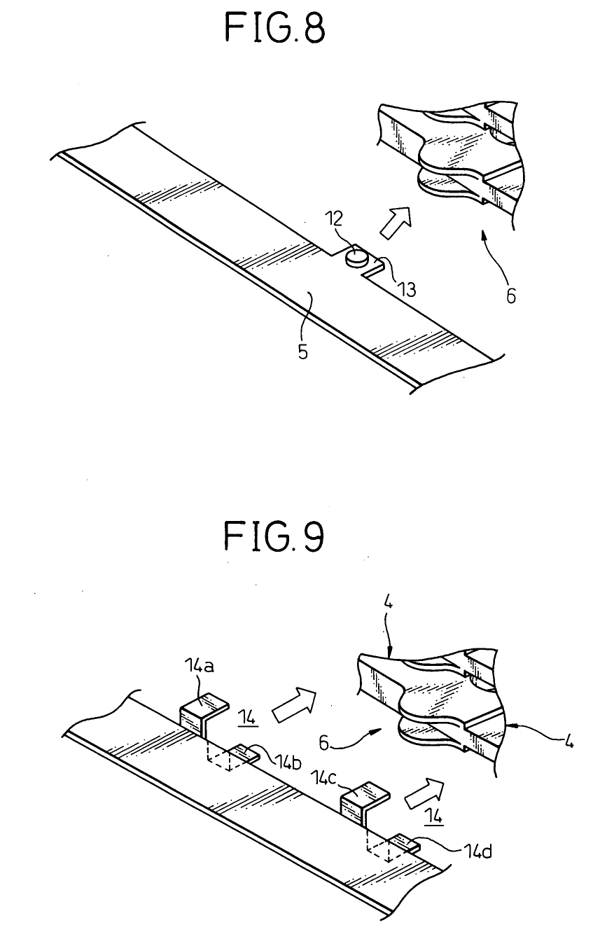

FIG. 8 is a perspective view of a fifth embodiment. As shown in the figure, in the fifth embodiment, the stainless steel sheet of the long tail 5 is provided with a part extending horizontally from the side face toward the actuator arm side (in other words, extending in a direction perpendicular to the long direction of the long tail) constituting a tab 13, the tab 13 is provided with an embossed part 12, and the embossed part 12 and upper wall or lower wall of the slit 6 form the above-mentioned friction structure. Note that the embossed part 12 can be formed as a projecting part simultaneously and integrally with the extend part when press forming the long tail suspension. Further, the height of the embossed part 12 can be set considering the thickness of the long tail suspension plate and the space of the slit 6 and their variances. Compared with the third embodiment (FIGS. 6A and 6B), there is no process of bending the tab, so adjustment of the distance between the bent sides becomes unnecessary and formation of the long tail 5 becomes easy.

FIG. 9 is a perspective view of a sixth embodiment. As shown in the figure, the magnetic head support mechanism 1 of the sixth embodiment is basically, like the first to fifth embodiments, a magnetic head support mechanism having an actuator arm 4 for holding a magnetic head suspension 3 and making the magnetic head 2 move to a predetermined location, a long tail 5 of a long tail suspension for laying signal lines connected to the magnetic head 2 along the actuator arm 4, and slits 6 provided at the side face of the actuator arm 4 and holding the long tail 5 at predetermined locations of the side face. The magnetic head support mechanism 1 of the sixth embodiment is provided with a friction mechanism for generating friction between the long tail 5 and the actuator arm 4 body to fasten the long tail 5 to the actuator arm 4.

Further, if analyzing FIG. 9, various features can be found. A first feature is that the long tail 5 of the long tail suspension has pairs of tabs 14a, 14bforming substantially L-sectional shapes sticking out from the side face toward the actuator arm 4 with tabs of each pair offset partially in the vertical and horizontal directions. These pairs of tabs 14a, and 14b grip the actuator arm 4 body to form the friction structure.

Further, a second feature is that a plurality (14c and 14d) of the pairs of tabs 14a and 14b are provided along the long direction of the long tail 5. This is because with only one pair of tabs, the long tail 5 has difficulty stably holding the actuator arm 4

Further, a third feature is the provision of two pairs of tabs (first pair of 14a and 14b and second pair of 14c and 14d ) straddling each slit 6 at the left and right.

In this embodiment, at the part of each slit 6, the long tail 5 is just simply supported, but the tabs (14a, 14b, 14c, and 14d) are formed by bending the stainless steel sheet, so have some springiness and grip the upper and lower surfaces of the actuator arm without clearance, so the long tail 5 can be reliably held.

Note that the distance between the upper and lower tabs of each pair (the first pair of 14a and 14b and the second pair of 14c and 14d ) is made substantially the same as or smaller than the thickness of the actuator arm considering the springiness of the tabs. Further, it is also possible to set the distance between the upper and lower tabs of each pair larger and bend the tabs in to fit them over the actuator arm when positioning the long tail 5 and the slits 6.

Therefore, positioning of the tabs 14 with the actuator arm 4 becomes easy and the long tail suspension can be held stably at the predetermined position. Further, in this embodiment, there is no need to make the long tail suspension part long like in the second embodiment or to bend the part of the long tail including the interconnect circuit. The friction structure can be realized by just modifying the long tail without requiring any complicated process.

As explained above, in the above embodiments, the long tail 5 cannot shift with respect to the slits 6 in the horizontal direction in the figure. The long tail can be held stably at the predetermined position.

While the invention has been described with reference to specific embodiments chosen for purpose of illustration, it should be apparent that numerous modifications could be made thereto by those skilled in the art without departing from the basic concept and scope of the invention.

1. A magnetic disk apparatus with a magnetic head support mechanism having an actuator arm for moving a magnetic head to a predetermined position, a long tail suspension having a long tail for laying signal lines connecting to the magnetic head along the actuator arm, and a slit provided at a side face of said actuator arm for holding the long tail, wherein the apparatus is provided with a friction structure for generating friction between said long tail and the walls of said slit to fasten the long tail with respect to said slit.

2. A magnetic disk apparatus as set forth in claim 1, wherein said slit is comprised of at least three holding members arranged alternately in the vertical and horizontal directions so as to sandwich said long tail from the top and bottom while maintaining it substantially horizontal and wherein said holding members and said long tail form said friction structure between them.

3. A magnetic disk apparatus as set forth in claim 2, wherein said plurality of holding members push against said long tail from the vertical and horizontal sides so as to deform it into a bow shape.

4. A magnetic disk apparatus as set forth in claim 1, wherein said long tail is formed into a wave shape comprised of alternate peaks and valleys along the long direction and the thus made flexible wave shaped long tail and walls of said slit form said friction structure.

5. A magnetic disk apparatus as set forth in claim 4, wherein said long tail is made said wave shape only at a part along said long direction to be inserted into said slit.

6. A magnetic disk apparatus as set forth in claim 1, wherein said long tail has a U-sectional shaped tab extending out partially from its side face and said tab and the walls of said slit form said friction structure.

7. A magnetic disk apparatus as set forth in claim 6, wherein said long tail has a U-sectional shaped tab extending out partially from its side face, said tab is provided with an embossed part, and said embossed part and the walls of said slit generate said friction.

8. A magnetic disk apparatus as set forth in claim 1, wherein said long tail has a tab extending out partially from its side face, said tab is provided with an embossed part, and said embossed part and the walls of said slit generate said friction.

9. A magnetic disk apparatus as set forth in claim 1, wherein said long tail has a tab extending out partially from its side face, said tab is provided with an embossed part, and said embossed part and the walls of said slit generate said friction.

10. A magnetic disk apparatus with a magnetic head support mechanism having an actuator arm for moving a magnetic head to a predetermined position and a long tail suspension for laying signal lines connecting to the magnetic head along the actuator arm, wherein the apparatus is provided with a friction structure for generating friction between said long tail suspension and said actuator arm to fasten the long tail suspension with respect to said actuator arm.

11. A magnetic disk apparatus as set forth in claim 10, wherein said long tail suspension has a pair of tabs extending out partially from its side face toward said actuator arm, the tabs being offset in the vertical and horizontal directions, and the tabs sandwich said actuator arm between them to form said friction structure.

12. A magnetic disk apparatus as set forth in claim 11, wherein a plurality of pairs of tabs are provided along a long direction of said long tail suspension.

13. A magnetic disk apparatus as set forth in claim 12, wherein two pairs of tabs are arranged straddling a slit at the left and right.

14. A long tail suspension having a long tail by which signal lines connecting to the magnetic head are laid along an actuator arm and held by a slit provided at a side face of said actuator arm,
said suspension provided with a friction structure for generating friction between said long tail and walls of said slit to fasten the long tail with respect to said slit.

15. A long tail suspension as set forth in claim 14, wherein said long tail is formed into a wave shape comprised of alternate peaks and valleys along the long direction and the thus made flexible wave shaped long tail and walls of said slit form said friction structure.

16. A long tail suspension as set forth in claim 15, wherein said long tail is made said wave shape only at a part along said long direction to be inserted into said slit.

17. A long tail suspension as set forth in claim 14, wherein said long tail has a U-sectional shaped tab extending out partially from its side face and said tab and the walls of said slit form said friction structure.

18. A long tail suspension as set forth in claim 14, wherein said long tail has a U-sectional shaped tab extending out partially from its side face, said tab is provided with an embossed part, and said embossed part and the walls of said slit generate said friction.

19. A long tail suspension for laying signal lines connecting to a magnetic head along an actuator arm for moving said magnetic head to a predetermined position, the suspension provided with a friction structure for generating friction with said actuator arm to fasten it with respect to said actuator arm.

20. A long tail suspension as set forth in claim 19, wherein said suspension has a pair of tabs extending out partially from its side face toward said actuator arm, the tabs being offset in the vertical and horizontal directions, and the tabs sandwich said actuator arm between them to form said friction structure.
